(19) United States
(12) Patent Application Publication
(10) Pub. No.: US 2010/0176349 A1
(43) Pub. Date: Jul. 15, 2010

(54) REDOX FRACTIONATION OF SINGLE-WALLED CARBON NANOTUBES

(75) Inventors: Howard K. Schmidt, Cypress, TX (US); Robert H. Hauge, Houston, TX (US); Noe T. Alvarez, Houston, TX (US)

Correspondence Address: WINSTEAD PC, P.O. BOX 50784, DALLAS, TX, 75201, US

(73) Assignee: Willaim Marsh Rice University, Houston, TX (US)

(21) Appl. No.: 12/443,213

(22) PCT Filed: Sep. 27, 2007
(86) PCT No.: PCT/US07/79744

§ 371 Date: Mar. 4, 2010

Related U.S. Application Data
(60) Provisional application No. 60/848,468, filed on Sep. 29, 2006.

(51) Int. Cl. H01B 1/04; C01B 31/00; B07B 13/00

(52) U.S. Cl. 252/502; 204/173; 209/3.1; 977/750

(57) ABSTRACT

A method for separating fractions of single-walled carbon nanotubes includes exposing a solution containing fractions of single-walled carbon nanotubes to a reducing agent and separating the resulting reaction products. An alternate method for separating fractions of single-walled carbon nanotubes includes exposing a solution containing fractions of single-walled carbon nanotubes to an oxidizing agent and separating the resulting reaction products. A third method for separating fractions of single-walled carbon nanotubes includes exposing a solution containing fractions of substantially non-functionalized single-walled carbon nanotubes to a charge transfer complex agent and separating the resulting reaction products. These methods allow the production of single-walled carbon nanotubes of approximately 95 to 99% metallic and semiconducting types.

### CROSS REFERENCE TO RELATED APPLICATIONS

This application claims priority to U.S. Provisional Patent Application 60/848,468, filed Sep. 29, 2006 and is incorporated by reference herein in its entirety.

### STATEMENT REGARDING FEDERALLY SPONSORED RESEARCH OR DEVELOPMENT

This work was performed with support from NASA under contract number NNJ05HE75A.

### BACKGROUND

Two valuable species of single-walled carbon nanotubes (SWNTs) are metallic, which allow electrical current to flow freely similar to a metal circuit, and semiconducting, where the tube contains energy gaps that slow electrical current so that it acts more like a semiconductor circuit. These energy gaps, called “bandgaps”, do not permit energy to pass freely through the nanotube. The combination of pitch of the graphene sheet bound into a cylindrical shape to its long axis, otherwise known as chirality, as well as the cylinder's diameter, affects the size of the bandgaps and therefore the level of conductivity of the SWNT.

Numerous efforts in sorting SWNTs by metallic and semiconducting types have been based on selective dissolution of SWNTs from buckypapers. This has proven impractical for generating large quantities of particular SWNT types. Other methods to separate SWNT types have relied on the functionalization of SWNTs via degradative treatments with strong oxidizing acids, for example. While purities of SWNT types as high as 92% have been reported, the degradative functionalization used to carry out this separation diminishes the value of the separated SWNTs relative to theoretical pure populations of non-functionalized (pristine) SWNTs, i.e. SWNTs that have not been treated with strong oxidizing agents. A need remains for a method for reliably separating semiconductor SWNTs from metallic SWNTs to a level of purity that permits their commercial use in high-end applications while preserving SWNT structure.

### SUMMARY

In one aspect, embodiments disclosed herein relate a method for separating fractions of single-walled carbon nanotubes that includes exposing a solution containing fractions of single-walled carbon nanotubes to a reducing agent and separating the resulting reaction products.

In another aspect, embodiments disclosed herein relate to a method for separating fractions of single-walled carbon nanotubes that includes exposing a solution containing fractions of single-walled carbon nanotubes to an oxidizing agent and separating the resulting reaction products.

In yet another aspect, embodiments disclosed herein relate to a method for separating fractions of single-walled carbon nanotubes that includes exposing a solution containing fractions of substantially non-functionalized single-walled carbon nanotubes to a charge transfer complex agent and separating the resulting reaction products.

In still another aspect, embodiments disclosed herein relate to single-walled carbon nanotubes of approximately 95 to 99% purity in either metallic or semiconducting types.

The foregoing has outlined rather broadly the features and technical advantages of a number of embodiments disclosed herein in order that the detailed description that follows may be better understood. Additional features and advantages will be described hereinafter.

### BRIEF DESCRIPTION OF THE DRAWINGS

The foregoing summary as well as the following detailed description of various embodiments will be better understood when read in conjunction with the appended drawings. It should be understood, however, that embodiments disclosed herein are not limited to the precise arrangements and instrumentalities shown herein. The components in the drawings are not necessarily to scale, emphasis instead being placed upon clearly illustrating the principles of various embodiments.

The invention may take physical form in certain parts and arrangement of parts. For a more complete understanding of various embodiments, and the advantages thereof, reference is now made to the following descriptions taken in conjunction with the accompanying drawings, in which:

FIGS. 1a-1d show NIR-fluorescence at 785 nm excitation wavelength for Fe²⁺ and Fe³⁺ at different ratios of Fe salt atoms to carbon atoms present in SWNT/SDBS solution.

FIG. 1a shows a plot after treatment with various levels of Fe²⁺ on a common scale.

FIG. 1b shows a plot after treatment with various levels of Fe²⁺ on a normalized scale.

FIG. 1c shows a plot after treatment with various levels of Fe³⁺ on a common scale.

FIG. 1d shows a plot after treatment with various levels of Fe³⁺ on a normalized scale.

FIG. 2a shows overlaid fluorescence spectra showing the fluorescence change of SWNTs due to Fe reduction of SWNTs/SDBS solution at pH 7 and pH 11. The “Reference” is the original SWNT/SDBS decant solution.

FIG. 2b shows overlaid UV-Vis spectra showing absorption of SWNTs in the SWNT/SDBS decant solution before and after treating the solution with Fe²⁺.

FIG. 3a shows the Raman spectra of the precipitate compared to the SWNT/SDBS reference solution before treating with Fe²⁺ at 514 nm.

FIG. 3b shows the Raman spectra of the precipitate compared to the SWNT/SDBS reference solution before treating with Fe²⁺ at 633 nm.

FIGS. 4a-4b show tapping mode AFM images of SWNTs treated with electrolytically generated Fe²⁺(OH)₂.

FIG. 5a shows overlaid normalized UV-Visible spectra of a SWNT/SDBS solution before (Reference) and after passing through a Cu powder packed column.

FIG. 5b shows overlaid baseline corrected UV-Visible spectra of a SWNT/SDBS solution before (Reference) and after passing through a Cu powder packed column.

FIG. 6 shows XPS spectra collected from the SWNTs/SDBS/Cu complexes deposited on a SiO₂ substrate (Cu₂O=932.5 eV and CuO=933.7).

FIG. 7a shows an AFM image of the film deposited with spin coating on a Cu treated SWNT TFT.

FIG. 7b shows an SEM image showing the complete surface of the thin film and the gold electrodes of a Cu treated SWNT TFT.

FIG. 7c shows a diagram of a FET and its components.

FIGS. 8a-8d show room temperature electrical performance of SWNT-TFTs built with Cu-treated (enriched) and HiPco (control) tubes.

FIG. 8a shows the I(V) curves with zero-gate bias, showing that the conductance of Cu treated SWNTs drops by more than one order of magnitude.

FIG. 8b shows the I_{D} vs. V_{GS} curves, showing that Cu treated SWNT-TFT exhibits a ON/OFF current ratio higher than 10⁴ at ±10 V gate bias.

FIG. 8c shows I_{D} vs. V_{DS} curves at different gate voltages (from 0 to −10 V, at −1 V steps) of SWNT-TFTs using Cu treated tubes.

FIG. 8d shows I_{D} vs. V_{DS} curves at different gate voltages (from 0 to −10 V, at −1 V steps) of SWNT-TFTs using HiPco tubes.

FIGS. 9a-9b show AFM images of Cu coated SWNTs with the height noted along side the structures.

FIG. 10 shows a proposed reduction potential scheme for semiconductor SWNTs related to their fluorescence wavelength and diameter under 785 nm excitation wavelength. Fluorescence spectra are shown in the upper part of the diagram.

### DETAILED DESCRIPTION

Single-wall carbon nanotubes (SWNTs) are well known for their interesting electronic and mechanical properties. Current HiPco SWNT production technologies generate a complex mixture of tube types that are generally about 1 nm in diameter (range: 0.6 to 1.4 nm) and 1 μm long (range: 0.1 to 10 μm, although much longer samples exist). Approximately one third are metallic (0 eV bandgap) or semi-metallic (1-10 meV bandgap) and two-thirds are semiconducting (0.8-1.4 eV) nanotubes; the metallic and semi-metallic SWNTs will be collectively called metallic SWNTs here. The unique tubular arrangement (diameter and chirality) of the carbon lattice in each nanotube determines its metallic or semiconducting nature. The semiconductors have a direct bandgap and high carrier mobility; their application in molecular electronics, ballistic field effect transistors (FETs), optoelectronics and chemical sensors are particularly promising. Applications for metallic SWNTs include nanomechanical switches, electronic interconnect, antennas and transparent conductors. The performance of devices that were built to take advantage of the physical properties of semiconductor SWNTs were or would be diminished by the presence of metallic nanotubes, and vice-versa. Many practical applications will require SWNTs selected to have at least the same electronic class (metallics or semiconductors); production or separation of specific types would optimize particular applications. A versatile and moderately scaleable technology that would separate SWNTs by type is needed to support advanced device and application development.

There are many SWNT separation or enrichment techniques reported including, for example, by length, type, and diameter. Such techniques include, for example, size exclusion chromatography, gel permeation chromatography, gel electrophoresis, ion exchange liquid chromatography, dispersion-centrifugation, density-gradient ultracentrifugation, dielectrophoresis, current induced selective breakdown, covalent functionalization, selective adsorption, ion exchange and electrophoresis.

As stated above, high-end applications of metallic and semiconducting SWNTs place a demand on the development of techniques for providing high purity pristine SWNT types. Thus, “SWNTs” as used herein generally refer to SWNTs that are pristine for high-end use in electronics applications. In one embodiment the SWNTs are non-functionalized or, as referred commonly in the art, “pristine SWNTs.” SWNTs that have undergone treatment with strong oxidizing acids, for example, may also be used, however, one skilled in the art will recognize that such SWNTs will have compromised structures due to oxidative degradation, including at defect sites in the SWNTs, that leads to diminished effectiveness in the various high-end applications envisioned.

A small percent impurity of metallic SWNTs in a batch of semiconductor SWNTs can have a profound impact on the ability to obtain a low leakage current in semiconductor devices, similar to the problem with contaminants in silicon devices. Additionally, a few percent of semiconductor impurity SWNTs in a metallic SWNT sample will create a degradation in overall metallic conductivity. Thus, in some embodiments, the present disclosure provides a method for separating fractions of single-walled carbon nanotubes (SWNTs) that includes exposing a solution containing fractions of single-walled carbon nanotubes to a reducing agent and separating the resulting reaction products. Applicants have recognized the differences in redox potentials of metallic and semiconducting SWNTs and have devised a separation scheme based on selective redox chemistry.

The various methods of the present disclosure take advantage of the discovery that the oxidization potential of metallic SWNTs is higher relative to the oxidation potential of semiconductor SWNTs. Since the metallic SWNTs have a different oxidation potential than their semiconductor counterparts, this difference can be used to reliably identify and selectively separate the metallic SWNTs from the semiconductor SWNTs from a heterogeneous mixture of the two species. Since metallic SWNTs have a higher oxidation potential than semiconductor SWNTs, reducing agents for inducing reduction-oxidation (redox) reactions can be selected that will create preferential selection of the metallic SWNTs while not interacting significantly with the semiconductor SWNTs, thereby separating each from the other and allowing later refinement of each.

Oxidation-reduction chemistry is a method that has been known to have success for separating small molecules and atoms. However, its application to nanotubes has been difficult, in part due to size considerations. In particular, the effect of the finite size of a nanotube on its electronic properties, such as the influence of tube diameter on band structure, has not been well characterized. The energetics of electrons in a SWNT may be expected to influence the energetics of removing or adding an electron to the SWNT and, in turn, the reduction-oxidation chemistry of the nanotube. The interaction of nanotubes with electrolyte solutions continues to be an area of study. For example, Murakoshi (Physical Rev. B 68, 035434 (2003)) has reported the absolute electrochemical potential of isolated SWNTs. However, because the nanotubes are isolated, solvent effects are not included. Applicants have introduced consideration of solvent effects to generate novel plots of the Fermi levels of metallic tubes in solution. Comparison of these plots with those of semiconducting tubes in solution led to the unexpected prediction that metallic SWNTs are more oxidizing than semiconducting SWNTs. Based on these plots, applicants discovered mild reducing agents capable of separating metallic from semiconducting SWNTs.

In various embodiments, methods for obtaining separated SWNTs begins with a SWNT decant. The individualized SWNTs can be suspended in a direct solvent, such as N-methyl pyrrolidone, or can be rendered soluble in an aqueous solution by using surfactants such as polyvinyl pyrrolidone or PLURONIC® surfactants (BASF, Florham Park, N.J.). The SWNT decant is then passed over or mixed with a reducing agent to either induce a redox reaction or form a heavy charge transfer complex between a transition metal used as a reducing agent and metallic SWNTs from the decant. In one embodiment of the invention, the decant is passed over powered iron or copper particles to remove metallic SWNT from the decant by redox reaction. The resulting reaction produces a reaction product precipitate that is composed of reduced metallic SWNTs. In another embodiment of the invention, reduced metal particles form heavy charge transfer complexes reaction products with the metallic SWNTs by adding transition metal salts into the decant that are then reacted with a base (e.g., potassium hydroxide) or a reducing agent (e.g., sodium borohydride). In all variations, the reaction occurs quickly.

In one embodiment the reducing agent has a standard reduction potential between about −0.5 V to about +0.2 V. Standard reduction potentials are generally scaled relative to a reference reaction for the formation of molecular hydrogen from two hydronium ions and two electrons. Any reducing agent having a standard reduction potential in this range may be useful for selective reduction. Flexibility in these ranges Such reducing agents may include, for example, any combination of a transition metal, a lanthanide, an actinide, a main group metal, and salts thereof. Transition metals (using the new IUPAC notation) may include, for example, Group 4 metals (Ti, Zr, Hf), the lanthanide metals (Ce, Pr, Nd, and the like), Group 5 metals (V, Nb, Ta), Group 6 metals (Cr, Mo, W), Group 7 metals (Mn, Tc, Re), Group 8 metals (Re, Ru, Os), Group 9 metals (Co, Ru, Os), Group 9 metals (Co, Ru, Ir), Group 10 metals (Ni, Pd, Pt), Group 10 metals (Ni, Pd, Pt), and Group 11 metals (Cu, Ag, Au).

In one embodiment, the reducing agent includes copper, which may include elemental copper, copper salts, and combinations thereof. In another embodiment, the reducing agent includes iron, which may include elemental iron, iron salts, and combinations thereof.

The reduced products generated may be separated by many means including by flocculation, precipitation, centrifugation, electrophoresis and electrochemical plating, for example. Separation between the reaction product SWNTs and SWNTs remaining in solution can occur using several methods. In some embodiments, one may add a flocculating agent to encourage physical separation. In most cases, gravity, especially by use of centrifugation, separates the species since the transition metal complex SWNTs are heavier than the unreacted and suspended SWNTs. In some embodiments, the reaction product immediately precipitates out of the solution. In some embodiments, the reaction products possess a new charge state that permits electromigration or electrophoresis for separation. In some embodiments, differential ion mobility may be used as a method for separating the reaction product.

If the desired fraction is complexed, one can then recover the SWNT fraction material by selectively dissolving the complexing metal by use of an acid (e.g., mild hydrochloric acid for iron or copper species) and then removing the dissolved salts from the SWNT product (e.g., by dialysis). If the desired fraction is flocculated, one can recover the SWNT fraction by filtration on a membrane. Gravity sedimentation may be accelerated by centrifugation as well. Washing the fraction with a mild acid solution to further remove flocculating agents enhances recovery.

The aforementioned method is also effective in not only separating metallic SWNTs from semiconductor SWNTs, but also fractionating semiconductor SWNTs for selective properties such as bandgap or oxidation potential. By selecting reducing agents with relatively stronger oxidation potentials, it is possible to precipitate a fraction of the semiconducting SWNTs (e.g., the smallest diameter tubes with the largest bandgaps) along with the metallic SWNTs. This occurs because the smaller diameter semiconductor SWNTs have a higher oxidation potential than the larger SWNTs with smaller bandgaps. By repeating a series of bifurcating separations, one can fractionate the semiconductor SWNTs by a selected range of bandgaps by redox potential.

In alternate embodiments, the present disclosure also provides a method for separating fractions of single-walled carbon nanotubes comprising exposing a solution containing fractions of single-walled carbon nanotubes to an oxidizing agent and separating the resulting reaction products. The oxidizing agent may have a standard reduction potential of about +0.5 V to about +1.5 V. Again any oxidizing agent falling within this range may be used. In an exemplary embodiment, the oxidizing agent may include gold and salts thereof. Similar separation techniques may apply to the resultant reaction products of oxidation.

In yet further embodiments, the present disclosure also provides a method for separating fractions of single-walled carbon nanotubes comprising exposing a solution containing fractions of substantially non-functionalized single-walled carbon nanotubes to a charge transfer complex agent and separating the resulting reaction products. In some embodiments, the charge transfer complex agent includes solubilized transition metal particles. Separating the resulting reaction products may be achieved by gravity separation, flocculation, precipitation, centrifugation, differential ion mobility, and electrodeposition, for example.

The various methods disclosed herein have produced both metallic and semiconductor SWNTs of approximately 95 to 99% purity. Thus, in some embodiments, the present disclosure envisions materials that include single-walled carbon nanotubes wherein approximately 95 to 99% of the single-walled carbon nanotubes are metallic. Alternatively, the present disclosure also envisions materials that include single-walled carbon nanotubes wherein approximately 95 to 99% of the single-walled carbon nanotubes are semiconducting.

### EXAMPLES

The following examples are provided to more fully illustrate some of the embodiments of the present invention. It should be appreciated by those of skill in the art that the techniques disclosed in the examples which follow represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

SWNTs for the following experiments were HiPco (Rice University Carbon Nanotechnology Laboratory) batch number 145.1 and all decants were prepared using DI water at 18 MΩ from a Barnstead reverse osmosis system. Reagents employed were used as received without further treatment unless noted; these include iron(III) chloride 98.1%, iron(II) chloride 99.5%, iron granules 99.98% (1-2 mm), copper powder 99% (325 mesh), and Cu(II) chloride 98% purchased from Alfa-Aesar. Iron powder 99% and sodium hydroxide were purchased from Fisher and SDBS was purchased from Sigma-Aldrich. While some solutions were degassed with ultra high purity nitrogen gas from Matheson Tri-Gas for 60 min prior to reactions, no significant differences in the results were observed between those and non-degassed samples. Unless otherwise noted, reactions were performed in either Pyrex glassware or soda-lime scintillation vials without flame drying or any other treatment.

Decants were produced from raw SWNTs and 1% SDBS dispersed in 200 mL of DI water using high shear mixing for 1 h (DREMEC Multipro Mod. 275). The dispersion was sonicated using a cup horn sonicator (Cole Parmer CPX-600) for 10 min. After sonication, the sample was centrifuged (Sorvall 100S Discovery ultracentrifuge with Surespin 630 swing-bucket rotor) at 129,000 G for 4 h.

NIR-Fluorescence spectra were obtained with a Nanospectralizer system (Applied NanoFluorescence, LLC, Houston Tex.) fitted with quartz four-window cuvettes (Starna Cells, Inc.). The UV-visible spectra collected with the Nanospectralizer were compared with UV-visible spectra recorded using a Shimadzu UV-3101PC, using quartz cuvettes from Starna, and no difference was observed in the range of analysis.

AFM Images were recorded with a Digital Instruments IIIA in tapping mode. Silicon substrates approximately 1 cm² for AFM imaging and electrical testing were cut from three inch wafers that were boron p-doped with 100 nm of thermal oxide. Oxide was removed from the backside of these wafers using 10% aqueous HF for 5 min or until a grayish color appeared, to facilitate electrical contact for back-gating experiments.

### Example 1

Discovery: Discovery of the SWNT redox chemistry began as a simple control experiment stemming from work on dielectrophoresis field-flow fractionation (DEP-FFF). Applicants were routinely monitoring enrichment and separation of various semiconducting SWNT species in real-time with near infra red fluorescence (NIRF). In the course of rapidly surveying novel electrode geometries, a prototype was assembled that employed a mild steel component as one of the electrodes. Upon an initial test, depletion was observed of small diameter semiconducting SWNTs (those with E₁₁ emission below about 1100 nm) from the instrument's effluent stream even without applying the AC signal to drive dielectrophoresis. This potentially useful effect was transient, however, and eventually the full complement of SWNT species passed through the system. It was speculated that the freshly cleaned steel electrode might be generating iron ions and that these might be involved in the transient depletion.

### Example 2

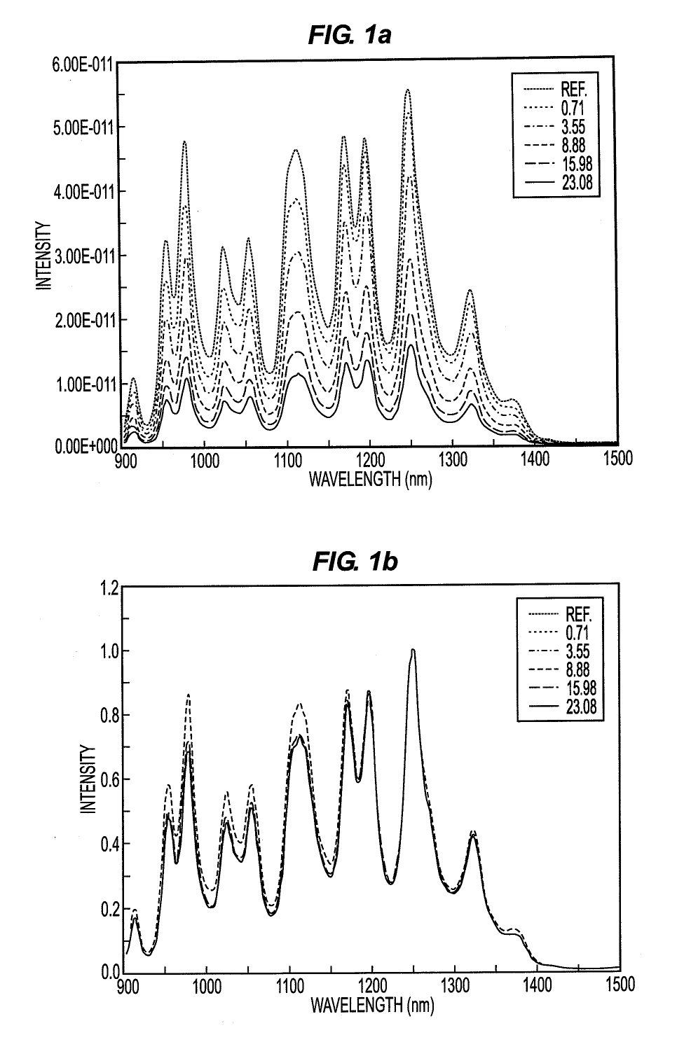

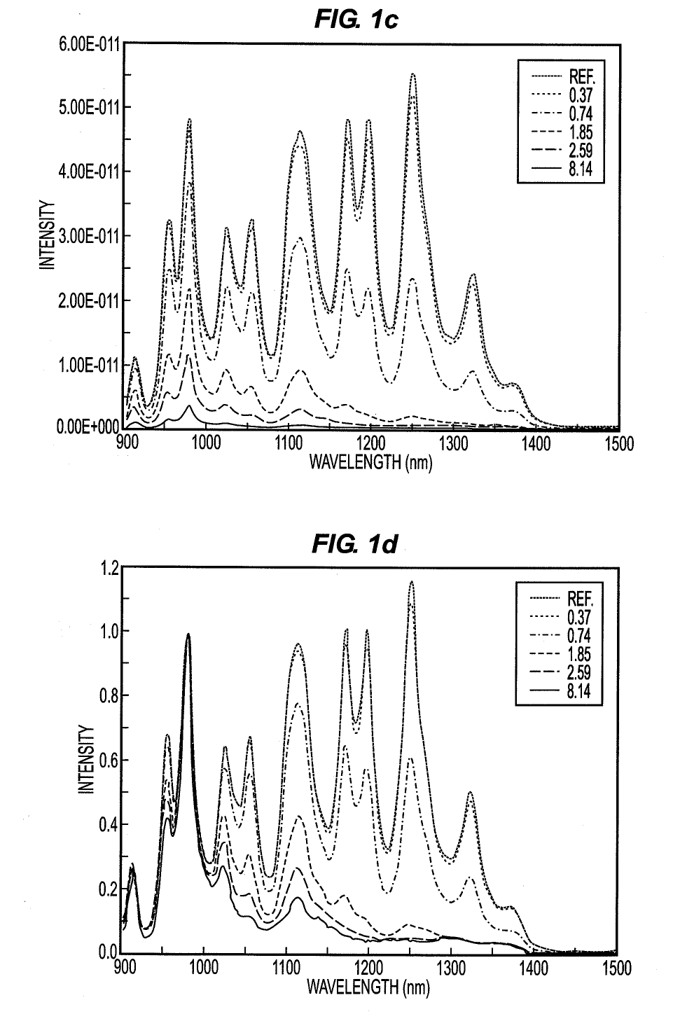

SWNT-Iron Redox Reactions Fe salts: FIG. 1. shows the NIR-fluorescence at 785 nm excitation wavelength for Fe²⁺ and Fe³⁺ at different ratios of Fe salt atoms to carbon atoms present in SWNT/SDBS solution. FIGS. 1a and 1b correspond to plots after treatment with various levels of Fe²⁺ on a common scale, and normalized, respectively. FIGS. 1c and 1d correspond to plots after treatment with various levels of Fe³⁺ on a common scale, and normalized, respectively. The “Ref” line signifies the SWNT/SDBS spectrum before metal addition.

The effect of Fe²⁺ and Fe³⁺, as well as Fe metal as the source of ions, on the fluorescence of SWNTs species suspended in SDBS decants was systematically examined. It was found that Fe²⁺ and Fe³⁺ species, both supplied as the chlorides, generally suppressed fluorescence of the SWNT decants (FIG. 1). However Fe²⁺ quenched non-selectively (FIGS. 1a and 1c) while Fe³⁺ selectively quenched the fluorescence of the larger diameter semiconducting nanotubes, specifically those with emissions at wavelengths greater than about 1050 nm (FIGS. 1b and 1d). The mechanism appears to be a selective quenching of the large semiconductor SWNTs by an oxidative electron transfer reaction from the nanotube to Fe³⁺, an inorganic version of the redox process previously demonstrated by Doom using organic charge transfer reagents. [O'Connell, M. J.; Eibergen, E. E.; Doom, S. K. Nature Materials 2005, 4, 412-418.] The range of fluorescence quenched is consistent with the known oxidation potential of Fe³⁺ relative to the normal hydrogen electrode (NHE) (Equation 1).

Fe³⁺+e⁻−>Fe²⁺@+0.771V vs. NHE (1)

Both the general fluorescence suppression and quenching by both Fe³⁺ and Fe²⁺ were reversible upon increasing the pH to 10 with sodium hydroxide. These results demonstrate that oxidation by the higher-valent Fe²⁺ or Fe³⁺ ions from chlorides cannot generate the originally observed steel wire-based selective quenching of fluorescence of small diameter semiconductor nanotubes.

### Example 3

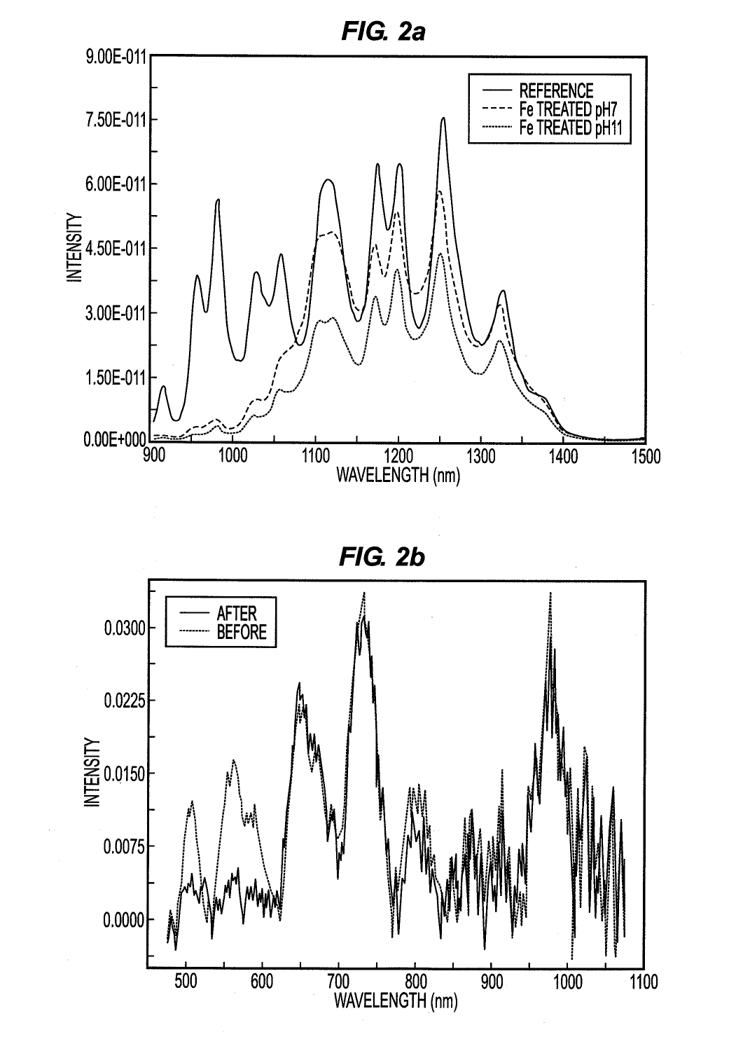

Iron particles: Applicants further examined potential SWNT reductive processes by passing SWNT/SDBS decants over a packed bed of freshly cleaned iron particles and powder and by generating reduced iron colloids in-situ. The first approach produced a solution with diminished fluorescence by small semiconducting SWNTs as shown in FIG. 2a. FIG. 2a shows the fluorescence change of SWNTs due to Fe reduction of SWNTs/SDBS solution. The “Reference” line is the original SWNT/SDBS decant solution. A vial with 10 mL SWNTs/SDBS solution was packed with Fe (steel wool) and left for 12 h; the removed supernatant solution had a pH ˜7, the pH was increased to 11 by adding NaOH (0.1 N). FIG. 2b shows the UV-Vis absorption of SWNTs in the SWNT/SDBS decant solution before and after treating the solution with Fe²⁺.

Applicants observed in the UV-Visible absorption spectra from these reactions significantly reduced peaks attributed to metallic SWNTs, as shown in FIG. 2b, suggesting that electron transfer from iron species to metallic and small diameter SWNT occurred. From the absorption spectra, it was estimated that more than 85% of the original metallic SWNT absorption was depleted. The reduction processes generating these observations could be driven by either Fe⁰ (Eq 2) or Fe²⁺(OH)₂ (Eq 3).

Fe²⁺+e⁻.Fe⁰@−0.447V vs. NHE (2)

Fe³⁺(OH)₃+e⁻.Fe²⁺(OH)₂+OH⁻@−0.56V vs. NHE (3)

### Example 4

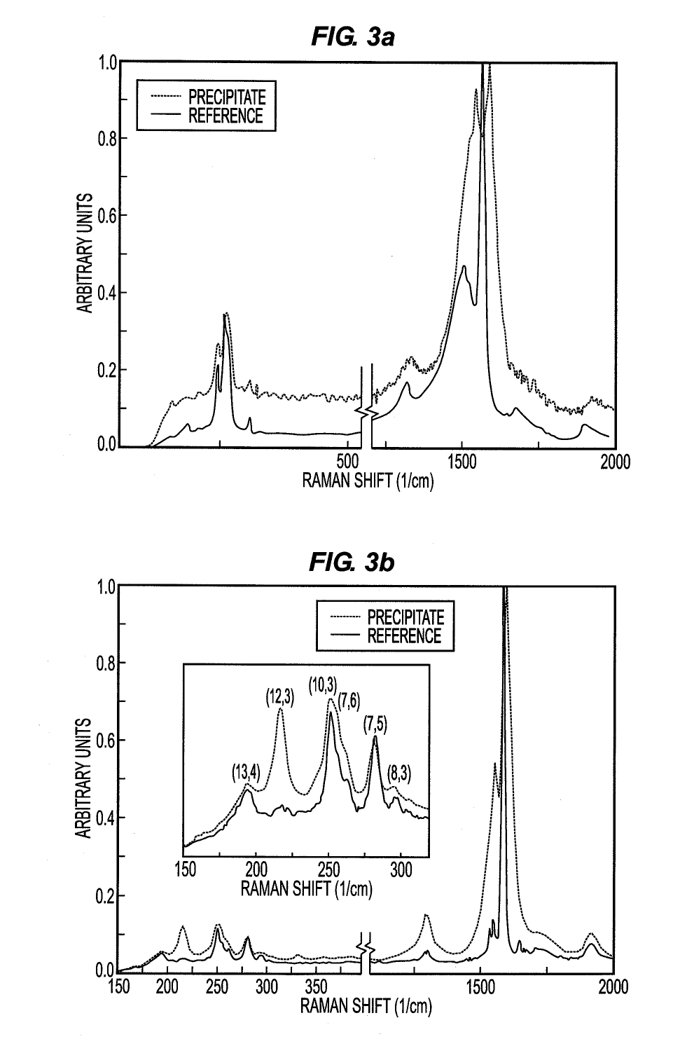

Iron colloids: In parallel experiments, iron colloids were generated by adding FeCl₃ (˜50 mg) into the SWNT/SDBS decant (5 mL, 4 mg/L). This generated a dark flocculate that quickly precipitated. The supernatant was removed from this solution by decanting, and added to another aliquot of SWNT/SDBS decant with a SWNT concentration of 4 mg/L and the sample was centrifuged for 60 min (120 g, swing-bucket rotor). The resulting supernatant solution appeared to be enriched in large-diameter semiconducting SWNT, as evidenced by reduced fluorescence for smaller tubes as well as decreased UV-Vis absorption in the metallic region between 500 and 600 nm, similar to the results from iron powders above. After increasing the pH of the solution to 7-8 with NaOH (0.1 N), the solution was further centrifuged at 129,000 G for 2 h and Raman spectra were obtained from the precipitated pellet using 514 nm excitation. The results are shown in FIGS. 3a and 3b. FIG. 3 shows the SWNT/SDBS and Fe²⁺ solution reactions at 514 nm (FIG. 3a) and 633 nm (FIG. 3b) excitation wavelength Raman spectra on the precipitate compared to the SWNT/SDBS reference solution before treating with Fe²⁺.

The spectra displayed a large increase in the G⁻ to G⁺ ratio, as shown in FIG. 3a, thereby indicating a high degree of enrichment of the metallic SWNTs in the pellet compared to the original solution. Further evidence is supplied by the Raman spectrum taken from the pellet at 633 nm excitation, as shown in FIG. 3b, which shows that the radial breathing mode peaks below 230 cm⁻¹ had increased significantly, indicating that metallic SWNTs (12,3) concentration had been enriched. Scheme 1 summarizes the selective SWNT redox equations proposed based on our observations.

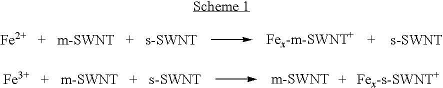

Further experiments, using Fe²⁺ generated in an electrolytic cell at pH ˜10 confirmed these results. At pH 8 or higher, the Fe²⁺/Fe³⁺ concentration ratio (as hydroxides) is greatly enhanced, creating a favorable condition for metallic SWNT reduction by Fe²⁺(OH)₂, thereby avoiding oxidation of large diameter semiconductor SWNTs. UV-visible absorbance spectra from the SWNTs decant solution after electrolytic processing showed significant depletion of metallic peaks below 630 nm. In addition, the fluorescence of large diameter semiconductors remained almost unchanged from the starting solution, indicating that only metallic and smaller semiconducting SWNTs form iron complexes under these conditions.

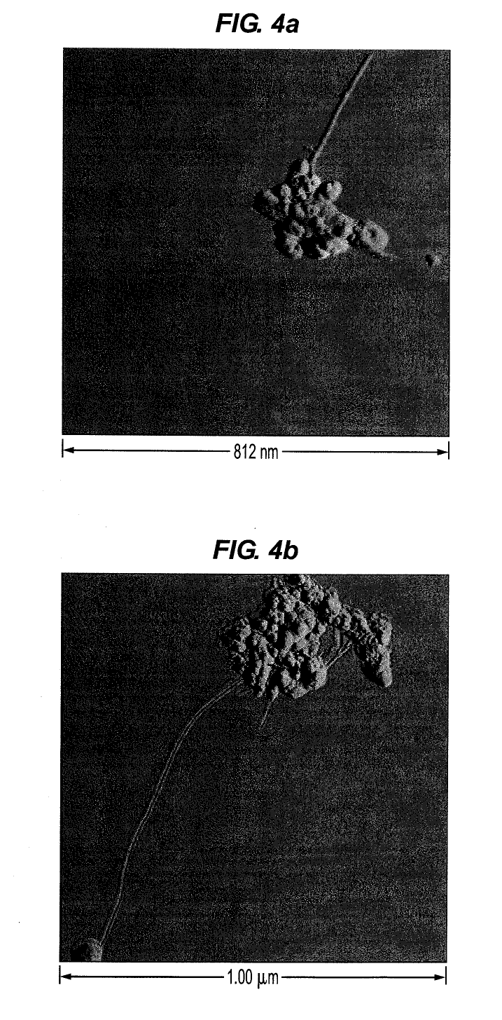

AFM images, shown in FIG. 4, taken of these samples show that a fraction of the tubes are quite long and without any visible coating or particulate matter on their surfaces, while other, shorter, tubes appear to be agglomerated in sizeable rounded particles. It was inferred that the long, pristine tubes are the semiconductors responsible for NIR fluorescence, while the agglomerated tubes are the metallic complexes whose UV-Visible absorption was bleached. FIG. 4 shows the tapping mode AFM images of SWNTs treated with electrolytically generated Fe²⁺(OH)₂; samples were spin-coated from 1% SDBS solution onto silicon surfaces.

### Example 5

SWNT-Copper Redox Reactions: Having established that metallic SWNTs could be selectively complexed with reducing species, and further that the reducing power of Fe⁰ or Fe²⁺(OH)₂ was sufficient to react with the smaller semiconducting species, applicants sought a slightly weaker reducing agent that might react exclusively with metallic SWNTs. Copper species were thought to be good candidates given the mild reducing potentials of Cu⁰ and Cu²⁺(OH)₂ cuprous hydroxide as shown in Eqs 4 and 5.

Cu²⁺(OH)₂+2e−.Cu+2OH⁻@−0.222V vs. NHE (4)

2Cu²⁺(OH)₂+2e−.Cu₂O+2OH⁻H₂O@−0.080V vs. NHE (5)

Also, Cu²⁺Cl₂ is a weaker oxidizer (Eq 6) than its ferric counterpart, Fe³⁺Cl₃, and therefore expected to generate weak and non-selective quenching, much like ferrous Fe²⁺Cl₂.

Cu²⁺+2e⁻.Cu⁰@+0.3419V vs. NHE (6)

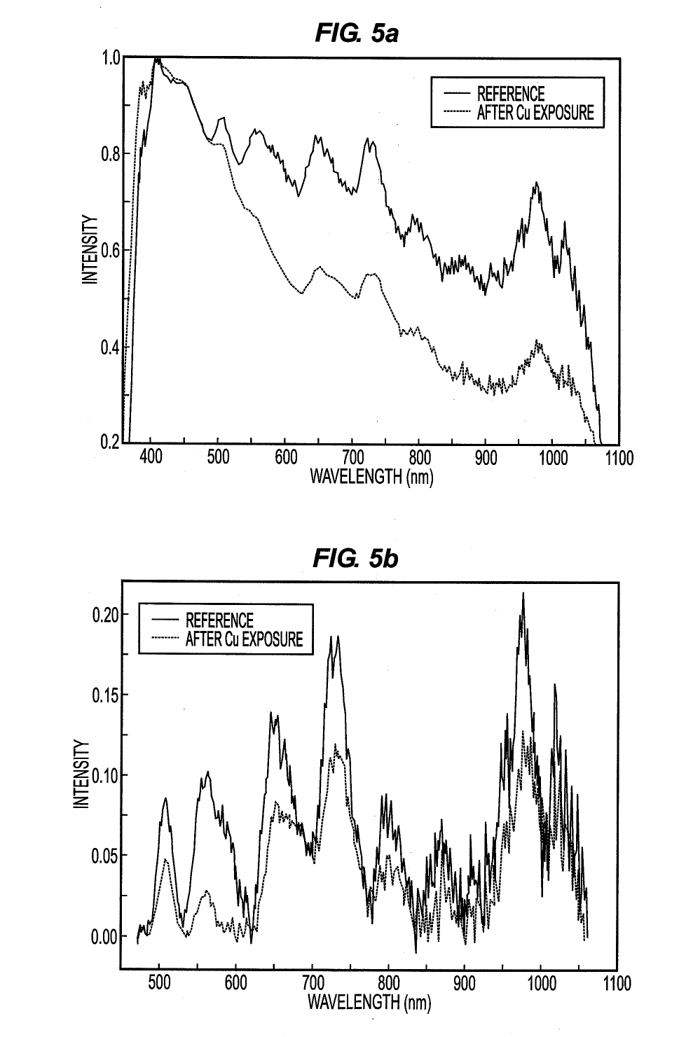

Indeed, NIR fluorescence spectra from SWNTs/SDBS decants treated with copper chloride resulted in moderate, non-selective quenching very much like that observed with ferrous chloride. Exposure of the SWNTs/SDBS solution to Cu powder produced results similar to those obtained from Fe metal; upon 2 h exposure with stirring, we found significant depletion of UV-Vis absorbance for the metallic SWNT peaks below 630 nm, as shown in FIGS. 5a and 5b. FIGS. 5a and 5b show the UV-Visible spectra of a SWNT/SDBS solution before (Reference) and after passing through a Cu powder packed column (FIG. 5a) normalized spectra (FIG. 5b) base line corrected. The supernatant in this reaction turned yellow, suggesting solubilization or production of species such as Cu₂O rather than CuO or Cu(OH)₂.

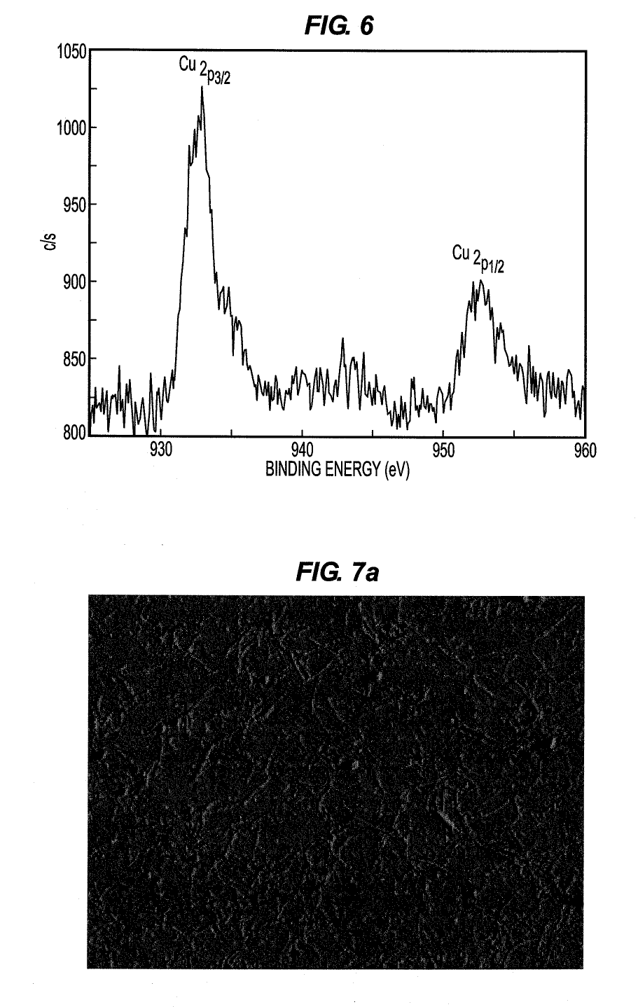

Additionally, X-ray photoelectron spectroscopy (XPS) data collected on a dried sample supports the presence of Cu₂O, although the binding energies of the oxides are very close and the peak is slightly broad eliminating the possibility of single oxide, as shown in FIG. 6. FIG. 6 shows the XPS spectra collected from the SWNTs/SDBS/Cu complexes deposited on a SiO₂ substrate (Cu₂O=932.5 eV and CuO=933.7). Cu₂O may behave as reducing agent, which might be responsible for the metallic SWNT reduction reaction.

### Example 6

Electrical Characterization: The SWNTs collected from the reaction after exposure to Cu power were dispersed on a silicon substrate to produce a thin film field effect transistor (FET), which was used to explore the electrical properties of the nanotubes in the semiconductor-enriched solution. The substrate silicon chips used were highly-doped n-type wafers covered with 200 nm thermal oxide dielectric layer (SQI, lot F-755-007-A). Deposition was accomplished by spin-coating one drop of semiconductor enriched SWNTs suspension at 3600 rpm, followed by an isopropanol rinse; dropping and rinsing was performed repeatedly to build up thin films of SWNTs. Ten such cycles generated suitable films, which were subsequently analyzed.

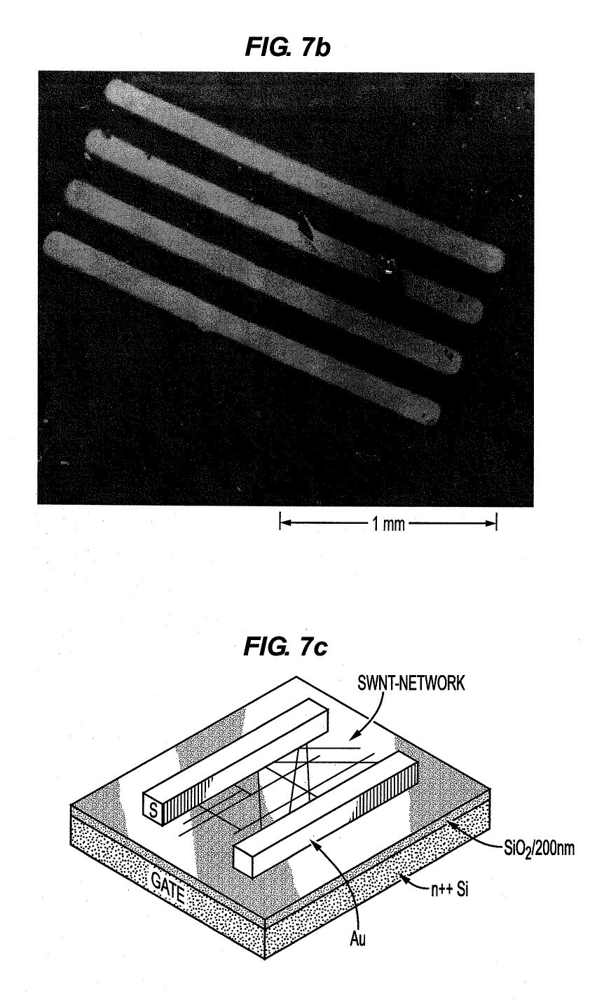

Control films were produced following the same procedure using HiPco SWNTs suspended in SDBS that had not been exposed to Cu powder. FIG. 7a shows an AFM image of a representative region of a typical SWNT thin film used in FET construction. An array of four 100×1000 μm contacts with 200 μm pitch were deposited on the film by sputtering 200 nm of gold through a shadow mask. The oxide on the back of each chip was removed with a drop of 30% HF to facilitate electrical contact to the substrate. The resulting structure is shown in FIG. 7b, and the overall device is shown schematically in FIG. 7c.

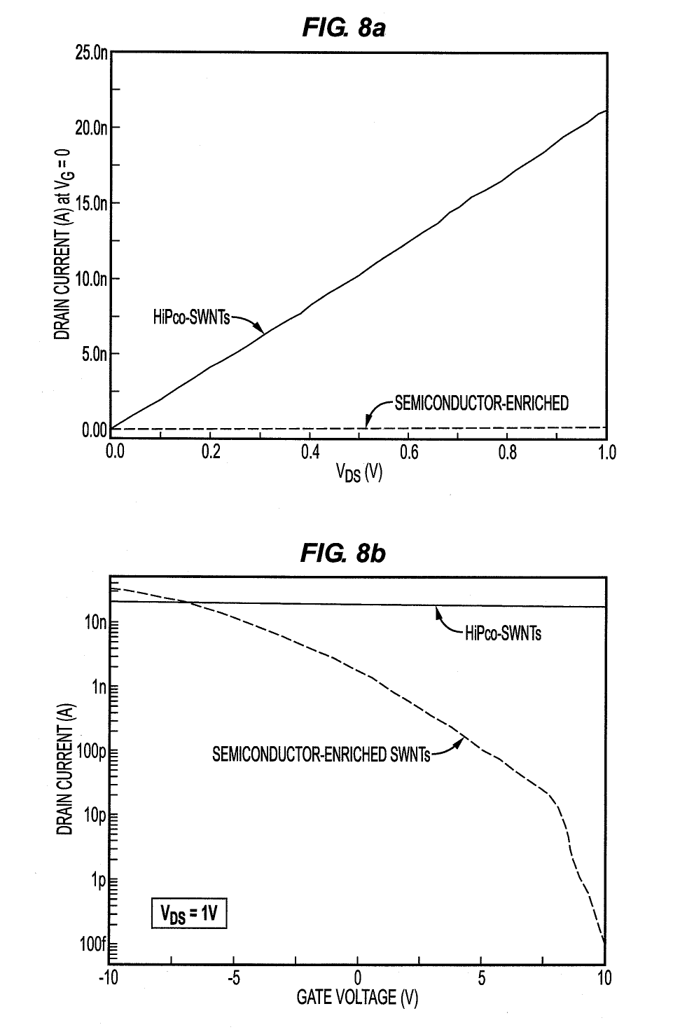

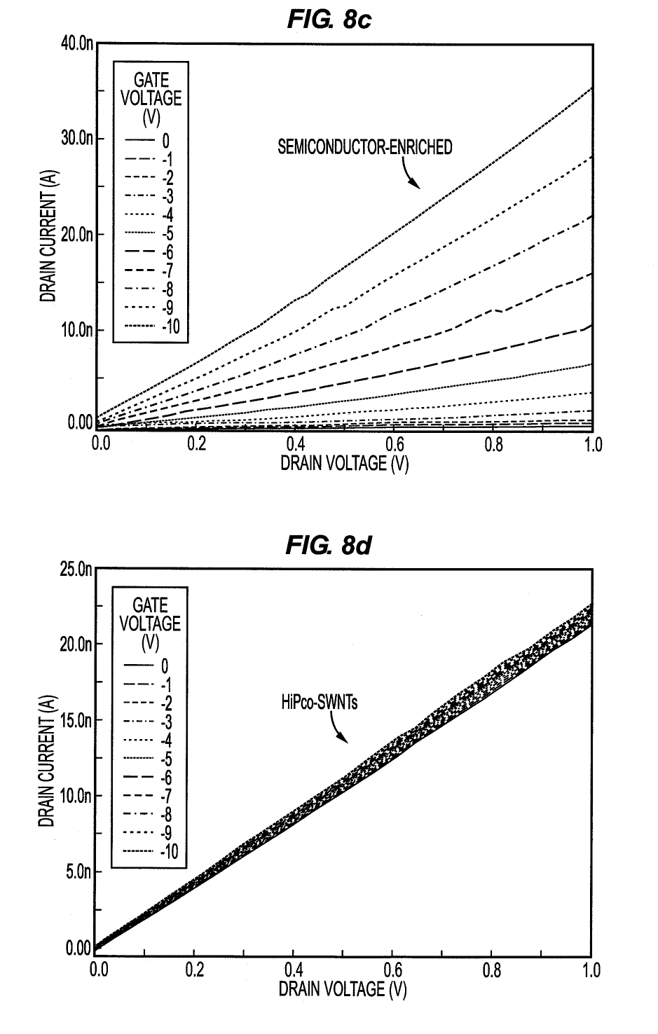

The room-temperature electrical transport properties of SWNT-TFTs were tested in a probe station (Desert Cryogenics TT-prober 6 system) under vacuum with base pressure below 5×10⁻⁵ Ton. These devices were contacted via tungsten probe tips, while the substrate served as the ‘back-gate’ which was contacted through the sample stage. I(V) characterization was performed on each adjacent pair of gold pads in the dark with an Agilent 4155C Semiconductor Parameter Analyzer. The results of these tests are shown in FIG. 8. FIG. 8 shows the room temperature electrical performance of SWNT-TFTs built with Cu-treated (enriched) and HiPco (control) tubes. a) I(V) curves with zero-gate bias, showing that the conductance of Cu treated SWNTs drops by more than one order of magnitude. b) I_{D} vs. V_{GS} curves, showing that Cu treated SWNT-TFT exhibits a ON/OFF current ratio higher than 10⁴ at ±10 V gate bias. c) and d) I_{D} vs. V_{DS} curves at different gate voltages (from 0 to −10 V, at −1 V steps) of SWNT-TFTs using Cu treated tubes and HiPco tubes, respectively. Little gate effect is observed in (b) and (d) that is consistent with the presence of a higher ratio of metallic tubes in the HiPco SWNT-TFTs.

Comparing the drain currents using a zero-biased gate (FIG. 8a), one observes that the control films made with untreated SWNT/SDBS decants have essentially purely resistive behavior and at least 100 times higher leakage current than the films produced with redox processed semiconducting SWNTs. FIG. 8b demonstrates that films from copper-treated decants produce p-type field effect transistor action with very low leakage currents and on/off current ratios better than 10⁴. Interestingly, the drain current for the copper-treated SWNT FET exceeds that of the control FET at high negative bias. From this result one could infer that the degree of semiconductor SWNT enrichment is quite high, supporting the spectroscopic results in FIG. 5.

However, it was subsequently found that pre-treating the semiconductor SWNTs-enriched suspension with nitric acid (to pH 1), in order to remove the particulate contamination found in the thin film (shown in FIG. 7a), caused the metallic peaks to partially reappear in the UV-Vis absorption spectrum of the resulting solution. This indicates that the metallic SWNTs in the copper-treated suspension used to produce the FETs discussed above had been electrically passivated, rather than physically separated. Since the Cu-treated metallic SWNTs, before HNO₃ treatment, no longer displayed their typical resonant absorptions, they must have been substantially electronically modified by interactions with copper species. In any event, the metallic tubes were no longer electrically active and the resulting FETs behaved as if the metallic tubes had been significantly removed from the solution. This represents a practical means for using redox passivation of the metallic SWNT species.

### Example 7

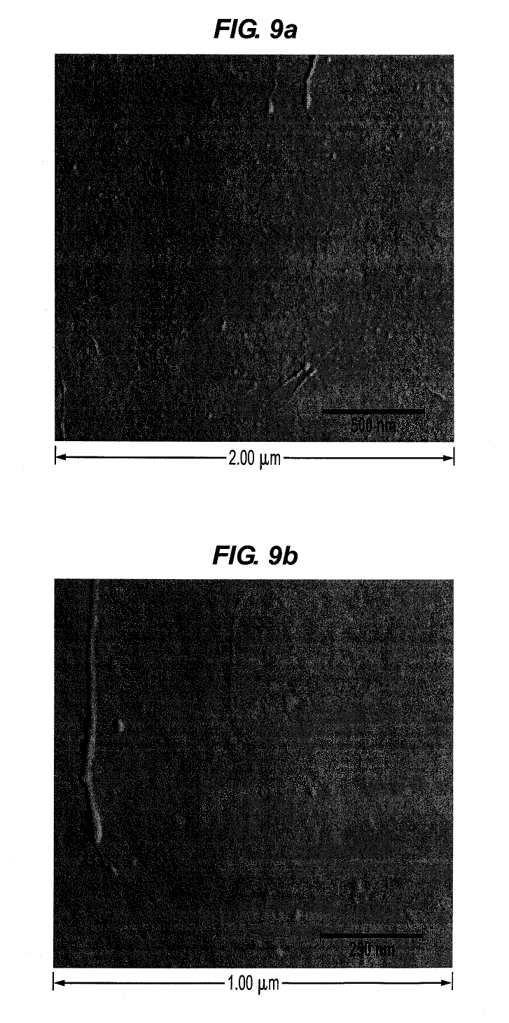

Two stage process: Applicants first treated an SDBS solution (1% by weight), without SWNTs, with Cu powder, which resulted in a yellow solution. This was centrifuged for 30 min (11K rpm bench centrifuge) and decanted to remove particulates and combined with a SWNTs/SDBS solution. Fluorescence and absorption spectra from the two-stage process were nearly the same as the original copper-SWNTs/SDBS reaction. The two-stage process product was used to make TFTs using the same process described above. Their electrical parameters were almost the same as the original copper-SWNTs/SDBS product. AFM images, shown in FIGS. 9a and 9b of the resulting SWNT product show a mixture of distinctly thin (average 1 nm diameter) and thick (average 4 nm diameter) nanotubes. FIGS. 9a and 9b show AFM images of Cu coated SWNTs (at black arrows) with the height noted along side the structures. Some have clean surfaces while others show higher thicknesses. The Cu treated SWNT/SDBS solution were deposited by spin coating on SiO₂ substrates.

These results support the idea that a copper complex (as yet unidentified) reacts reductively and highly selectively with metallic SWNT to generate a passive coating. It has been inferred that the copper-rich coating on the metallic SWNT must be oxidized to CuO or CuO₂. Either of these insulators would electrically isolate the tubes from the circuit network, consistent with the high quality FET characteristics described above. It is further noted that since the Cu-complexed metallic SWNTs must have chemically different surfaces than the un-complexed semiconducting SWNTs, the two species should be separable using known physical means.

### Example 8

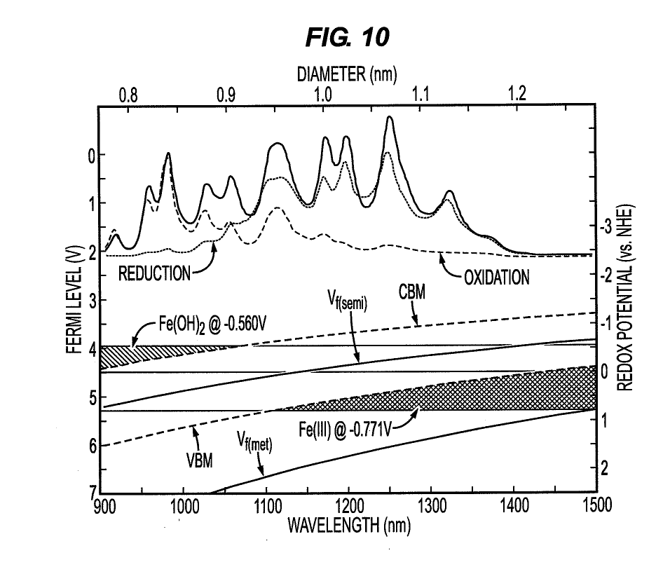

(Prophetic): Redox Potentials of Metallic SWNTs: The electrical results, supported by UV-Vis, Raman and NIR fluorescence spectra, comprehensively demonstrate an efficient route towards selective reactions with either semiconducting or metallic SWNT using a simple redox process. Based on the data, the mechanism appears to involve the reduction of metallic SWNTs by low-valent transition metal complexes. The redox level of metallic SWNTs in solution has not been quantified, but with these results one can begin to set some bounds. In defining these boundaries, it has been assumed that oxidation and reduction processes for semiconducting SWNTs in solution are fundamentally the same as those established for inorganic semiconductors in electrolytes, based on photocatalysis research as reviewed, for example, by Nozik. [Nozik, A. J. Annual Review of Physical Chemistry 1978, 29, 189-222.] It is expected that semiconducting SWNTs accept electrons at their conduction band minimum (CBM) and donate electrons from their valence band maximum (VBM), as indicated in FIG. 10.

FIG. 10. shows the proposed reduction potential scheme for semiconductor SWNTs related to their fluorescence wavelength and diameter under 785 nm excitation wavelength. Fluorescence spectra are shown in the upper part of the diagram. The horizontal line at −0.560 V on the right axis indicates the redox potential of the reducing agent and the horizontal line at 0.771 V on the right axis corresponds to the redox potential of the oxidizing agent, shown with their corresponding formulae on the diagram. The black area represents available electrons donated by Fe²⁺ into the CBM of semiconductor SWNTs and gray area represents electrons donated from VBM of semiconductor SWNTs to Fe³⁺. The metallics (V_{f(met)}) and semiconductors (V_{f(semi)}) solid curves are the Fermi levels (left axis) of the SWNTs based on equations derived by Okasaki. [Okazaki, K.; Nakato, Y.; Murakoshi, K. Phys. Rev. B 2003, 68, 354341-354345.] VBM and CBM are the black dashed lines above and below the semiconductor Fermi level.

Thus, we can locate the CBM of the small diameter semiconducting SWNT that react with Fe²⁺(OH)₂ but not Cu⁰ or Cu²⁺(OH)₂ in the range between −0.08 and −0.56 V vs. NHE. The selective nature of the reaction between the copper-SDBS complex and metallic SWNT requires that, as a class, their VBM is more positive than −0.08 V vs. NHE. This conclusion is consistent with the work of Okazaki, who determined absolute Fermi levels for both metallic and semiconducting SWNTs in an elegant spectroelectrochemical study based on the variation of intensity of Raman scattering peaks from individual SWNT radial breathing modes (RBMs) as a function of bias potential. Since RBM frequencies (ν_{rbm}) are uniquely related to nanotube diameter (dₜ) by Eq 7,

ν_{rbm}=A/dₜ+B (7)

(where A=223.5 cm⁻¹ and B=12.5 cm⁻¹), and the bandgap florescence wavelength (λ₁₁) of semiconducting SWNTs varies to first order inversely with diameter where λ₁₁=1167dₜ (both in nm), one can obtain simple relationships for the Fermi levels (and thus redox potentials) of SWNTs as a function of their fluorescence frequency and diameter. Combining Okazaki's equations, (Eqs 8 and 9):

V_{f(met)}=1.15+0.022*ν_{rbm} (8)

V_{f(semi)}=1.59+0.012*ν_{rbm} (9)

(V_{f(semi)}, V_{f(met)} in V below vacuum; ν_{rbm} in cm⁻¹) with the above relationships, one obtains Eqs 10 and 11 for the electrochemical potentials of metallic (Uₘₑₜ) and semiconducting (Uₛₑₘᵢ) SWNTs in anionic decants as a function of fluorescence frequency or diameter (Eqs 10 and 11, respectively).

V_{f(met)}=1.15+0.022*(12.5+223.5/dₜ) (10)

V_{f(semi)}=1.59+0.012*(12.5+223.5*1167/λ₁₁) (11)

This is shown graphically in FIG. 10, where one takes 0 V on the NHE electrochemical scale to correspond to a Fermi level 4.5 V below vacuum. The redox levels for key processes and resulting SWNT fluorescence spectra are shown to illustrate the redox chemistry in this system. It is noted that the curves drawn for semiconducting SWNTs are very similar to those reported by Doom, in their study of SWNT fluorescence quenching by organic acceptors. [O'Connell, M. J.; Eibergen, E. E.; Doom, S. K. Nature Materials 2005, 4, 412-418.] The curvature in Applicants' lines arise from the 1/dₜ and 1/λ₁₁ terms in Eqs 10 and 11, respectively. The curve for metallic SWNT in particular is an extrapolation of a relationship generated from nanotubes with a diameter of about 1.5 nm, while our HiPco SWNT have average diameters of about 1.1 nm. Thus, the indicated potentials for small metallic SWNTs much below 6 V vs. NHE are probably unrealistic, since oxidative reactions with water or surfactant would likely occur. However, this presentation of SWNT redox levels demonstrates that a reductive process must drive the selective reaction of low valent iron and copper species with metallic SWNTs.

While the valence levels indicated in FIG. 10 for semiconductors are supported by data from the NIR-Fluorescence quenching studies disclosed herein, the levels indicated for metallics should be considered approximate until further studies with well-characterized reactants can spectroscopically show distinguishable effects for metallic SWNTs of various diameters.

Advantageously, high-value applications envisioned for high-purity compositions of both metallic and semiconductor SWNTs become available through the various separation methods disclosed herein. For example, high-purity metallic SWNTs may be useful in creating thin transparent coatings; making thin polymer materials conductive, especially thin films used in such a manner as films currently incorporating indium tin oxide—touch-screens and computer displays; adding to substances to block microwave radiation, and providing interconnections with and between microelectronics.

High-purity semiconductor SWNTs are envisioned as useful for electronics and sensors just as traditional semiconductors. For example, with high-purity semiconductive SWNTs, devices such as transistors, particularly field-effect transistors, can be produced. These field-effect transistors can be created by depositing the semiconductive SWNTs onto the substrate lithography directly instead of being grown on the substrate. Such semiconductive SWNTs deposits will not need to be “burned out” or modified to change their properties so that they have low current leakage—the highly-pure semiconductive SWNTs will already possess the necessary low leakage attribute. Integrated circuits and transistor arrays are also envisioned from such a depositing method of highly-pure semiconductive SWNTs. Additionally, with a method of coordinating the subfractionization of semiconductive SWNTs, semiconductive SWNTs can be selected for particular purposes, such as refining and using only semiconductive SWNTs that have bandgaps between approximately 0.25 and 1.50 volts, the voltage range used with field effect transistors.

Other devices can be created by this subfractionalization of semiconductive SWNTs, such as photosensor devices. The selection method can preferentially separate out those semiconductive SWNTs that have the bandgap that would support light detection based upon known oxidation potentials. A transconductance chemical sensor can also be created, where a fractionalized semiconductive SWNT material is derived that would have a known reduction-oxidation (redox) potential, and in locating this fraction of semiconductive SWNTs they can be used to find other chemicals with matching redox potential. A combination of highly-purified and selected SWNT materials with a defined series of known redox potentials would work together as a chemical selectivity or agent identification tool.

What is claimed is:

1. A method for separating metallic single-walled carbon nanotubes from semiconducting single-walled carbon nanotubes, said method comprising:
exposing a solution comprising metallic single-walled carbon nanotubes and semiconducting single-walled carbon nanotubes to a reducing agent to form resulting reaction products; and
separating the resulting reaction products.

2. The method of claim 1, wherein the reducing agent has a standard reduction potential between about −0.5 V to about +0.2 V.

3. The method of claim 2, wherein the reducing agent is at least one metal species;
wherein the at least one metal species is selected from the group consisting of a transition metal, a lanthanide, an actinide, a main group metal, and salts thereof.

4. The method of claim 3, wherein the at least one metal species comprises copper.

5. The method of claim 3, wherein the at least one metal species comprises iron.

6. The method of claim 1, wherein separating the resulting reaction products occurs by flocculation.

7. The method of claim 1, wherein separating the resulting reaction products occurs by precipitation.

8. The method of claim 1, wherein separating the resulting reaction products occurs by centrifugation.

9. The method of claim 1, wherein separating the resulting reaction products occurs by electrophoresis.

10. The method of claim 1, wherein separating the resulting reaction products occurs by electrochemical plating.

11. A method for separating metallic single-walled carbon nanotubes from semiconducting single-walled carbon nanotubes, said method comprising:
exposing a solution comprising metallic single-walled carbon nanotubes and semiconducting single-walled carbon nanotubes to an oxidizing agent to form resulting reaction products; and
separating the resulting reaction products.

12. The method of claim 11, wherein the oxidizing agent has a standard reduction potential of about +0.5 V to about +1.5 V.

13. The method of claim 12, wherein the oxidizing agent comprises gold.

14. A method for separating metallic single-wall carbon nanotubes from semiconducting single-walled carbon nanotubes, said method comprising:
exposing a solution comprising substantially non-functionalized metallic single-walled carbon nanotubes and semiconducting single-walled carbon nanotubes to a charge transfer complex agent to form resulting reaction products; and
separating the resulting reaction products.

15. The method of claim 14, wherein the charge transfer complex agent comprises solubilized transition metal particles.

16. The method of claim 14, wherein separating the resulting reaction products occurs by gravity separation.

17. The method of claim 14, wherein separating the resulting reaction products occurs by flocculation.

18. The method of claim 14, wherein separating the resulting reaction products occurs by precipitation.

19. The method of claim 14, wherein separating the resulting reaction products occurs by centrifugation.

20. The method of claim 14, wherein separating the resulting reaction products occurs by differential ion mobility.

21. The method of claim 14, wherein separating the resulting reaction products occurs by electrodeposition.

22. A method for electrically passivating a mixture of single-walled carbon nanotube types, said method comprising:
treating the mixture of single-walled carbon nanotubes types with a copper source.

23. A material comprising single-walled carbon nanotubes wherein approximately 95 to 99% of the single-walled carbon nanotubes are metallic.

24. A material comprising single-walled carbon nanotubes wherein approximately 95 to 99% of the single-walled carbon nanotubes are semiconducting.
